(19) United States
(12) Patent Application Publication
(10) Pub. No.: US 2023/0195723 A1
(43) Pub. Date: Jun. 22, 2023

(54) ESTIMATION APPARATUS, LEARNING APPARATUS, ESTIMATION METHOD, LEARNING METHOD AND PROGRAM

(71) Applicant: NIPPON TELEGRAPH AND TELEPHONE CORPORATION, Tokyo (JP)

(72) Inventors: Soichiro KAKU, Musashino-shi, Tokyo (JP); Kyosuke NISHIDA, Musashino-shi, Tokyo (JP); Junji TOMITA, Musashino-shi, Tokyo (JP)

(21) Appl. No.: 17/996,247

(22) PCT Filed: May 20, 2020
(86) PCT No.: PCT/JP2020/019953

§ 371 Date: Oct. 14, 2022

(51) Int. Cl. G06F 16/242; G06F 16/22

(52) U.S. Cl. CPC G06F 16/2433; G06F 16/2282

(57) ABSTRACT

An estimating device according to an embodiment includes a first input processing unit that takes a question sentence relating to a database and configuration information representing a configuration of the database as input, and creates first input data configured of the question sentence, a table name of a table stored in the database, a column name of a column included in the table of the table name, and a value of the column, and a first estimating unit that estimates whether or not a column name included in the first input data is used in an SQL query for searching the database for an answer with regard to the question sentence, using a first parameter that is trained in advance

### TECHNICAL FIELD

The present invention relates to an estimating device, a learning device, an estimating method, a learning method, and a program.

### BACKGROUND ART

In recent years, a task called text to SQL, in which deep learning technology is used to estimate SQL (Structured Query Language) queries as to a DB (database) from natural language question sentences, is attracting attention. For example, NPL 1 proposes a deep learning model that takes a question sentence relating to a DB and a DB schema as input, and estimates an SQL query for acquiring an answer to the question sentence from the DB.

### CITATION LIST

### Non Patent Literature

[NPL 1] Rui Zhang, Tao Yu, He Yana Er,

Sungrok Shim, Eric Xue, Xi Victoria Lin, Tianze Shi, Caiming Xiong, Richard Socher, Dragomir Radev, “Editing-Based SQL Query Generation for Cross-Domain Context-Dependent Questions”, arXiv:1909.00786v2 [cs.CL] 10 Sep. 2019

### SUMMARY OF THE INVENTION

### Technical Problem

However, the conventional technology does not take into consideration the values of each column of a DB at a time of estimating an SQL query. The reason is that general-purpose language models (e.g., BERT (Bidirectional Encoder Representations from Transformers), RoBERTa (Robustly optimized BERT approach), and so forth) embedded in deep learning models used for text to SQL tasks have input length restrictions. Accordingly, it is conceivable that estimation precision may be lower or estimation itself be difficult regarding question sentences that require taking the values of each column of the DB into consideration at a time of estimating the SQL query, for example.

An embodiment of the present invention has been made in view of the foregoing, and it is an object thereof to enable taking values of each column of a DB into consideration as well, at a time of estimating SQL queries.

### Means for Solving the Problem

In order to achieve the above object, an estimating device according to an embodiment includes a first input processing unit that takes a question sentence relating to a database and configuration information representing a configuration of the database as input, and creates first input data configured of the question sentence, a table name of a table stored in the database, a column name of a column included in the table of the table name, and a value of the column, and a first estimating unit that estimates whether or not a column name included in the first input data is used in an SQL query for searching the database for an answer with regard to the question sentence, using a first parameter that is trained in advance.

### Effects of the Invention

Values of each column of a DB can be taken into consideration as well, at a time of estimating SQL queries.

### BRIEF DESCRIPTION OF DRAWINGS

FIG. 1 is a diagram showing an example of a DB configuration.
FIG. 2 is a diagram showing an example of a table configuration.
FIG. 3 is a diagram illustrating an example of a functional configuration of an estimating device at a time of inferencing (Example 1).
FIG. 4 is a diagram illustrating an example of a functional configuration of an estimating unit according to Example 1.
FIG. 5 is a flowchart showing an example of estimating processing according to Example 1.
FIG. 6 is a diagram for describing an example of processing of model input data according to Example 1.
FIG. 7 is a diagram illustrating an example of a functional configuration of the estimating device at a time of learning (Example 1).
FIG. 8 is a flowchart showing an example of learning processing according to Example 1.
FIG. 9 is a flowchart showing an example of parameter updating processing according to Example 1.
FIG. 10 is a diagram illustrating an example of a functional configuration of an estimating device at a time of inferencing (Example 2).
FIG. 11 is a flowchart showing an example of estimating processing according to Example 2.
FIG. 12 is a diagram for describing an example of processing of model input data according to Example 2.
FIG. 13 is a diagram illustrating an example of a functional configuration of the estimating device at a time of learning (Example 2).
FIG. 14 is a flowchart showing an example of learning processing according to Example 2.
FIG. 15 is a flowchart showing an example of parameter updating processing according to Example 2.
FIG. 16 is a diagram illustrating an example of a functional configuration of an estimating device at a time of inferencing (Example 3).
FIG. 17 is a flowchart showing an example of estimating processing according to Example 3.
FIG. 18 is a diagram illustrating an example of a functional configuration of the estimating device at a time of learning (Example 3).
FIG. 19 is a flowchart showing an example of learning processing according to Example 3.
FIG. 20 is a diagram illustrating an example of a hardware configuration of a computer.

### DESCRIPTION OF EMBODIMENTS

An embodiment of the present invention will be described below. In the present embodiment, a case will be described in which, when a question sentence regarding a DB, and configuration information of this DB (table names, column names in the table, and values of the columns) are given, each of two tasks are realized by a deep learning model. The two tasks are (1) a task of estimating whether or not a column name (note however, that column names joined by JOIN are excluded) is included in an SQL query for obtaining an answer to the question sentence, and (2) a task of estimating whether or not two column names in an SQL query for obtaining an answer to the question sentence are joined by JOIN (that is to say, the two column names are included in the SQL query, and also these two column names are joined by JOIN). Also described in the present embodiment is a task of estimating the SQL query for obtaining an answer to the given question sentence by using the estimation results of these two tasks (i.e., text to SQL tasks taking into consideration the values of the columns as well). Note that hereinafter SQL query may also be written simply as “SQL”.

### DB that is Object of Search

First, an example of a DB that is to be the object of searching by SQL for obtaining an answer to a given question sentence will be described. In the present embodiment, a DB of a configuration in which four tables that are shown in FIG. 1 are stored is the object, as an example. That is to say, the DB that is the object of searching stores four tables of a concert table, a singer table, a singer in concert table, and a stadium table. Also, the concert table is configured of a Concert_ID column, a Concert_Name column, a Stadium_ID column, and a Year column. In the same way, the singer table is configured of a Singer_ID column, a Name column, a Country column, a Song_release_year column, and an Is_male column, the singer_in_concert table is configured of a Concert_ID column, and a Singer_ID column, and the stadium table is configured of a Stadium_ID column, a Location column, a Name column, a Capacity column, a Highest column, a Lowest column, and an Average column. Note that FIG. 1 shows a DB schema, and that in addition to the table names and the column names, there may be included datatypes of column values, primary key column names, and so forth, for example.

Also, specific configurations of the concert table and the stadium table stored in the DB that is the object of searching are shown in FIG. 2 as an example. FIG. 2 shows the values of each column of the concert table, and the values of each column of the stadium table.

Note that FIG. 1 and FIG. 2 are examples, and that in the present embodiment, any RDB (Relational Database) can be the DB that is the object of searching.

### EXAMPLE 1

In Example 1, an estimating device 10 that realizes the task indicated in (1) above (i.e., the task of estimating whether or not a column name (note however, that column names joined by JOIN are excluded) is included in an SQL query for obtaining an answer to a question sentence), by a deep learning model, will be described. Note that with regard to the estimating device 10, there is a time of learning in which parameters of the deep learning model (Hereinafter, referred to as “model parameters”.) are learned, and there is a time of inferencing in which estimation is made regarding whether or not a column name (note however, that column names joined by JOIN are excluded) is included in the SQL for obtaining an answer to the given question sentence, by a deep learning model in which trained model parameters are set. Note that at the time of learning, the estimating device 10 may be referred to as a “learning device” or the like.

### Functional Configuration of Estimating Device 10 at Time of Inferencing (Example 1)

The functional configuration of the estimating device 10 at the time of inferencing will be described with reference to FIG. 3. FIG. 3 is a diagram illustrating an example of the functional configuration of the estimating device 10 at the time of inferencing (Example 1). Here, assumption will be made that question sentences and search object configuration information are given to the estimating device 10 at the time of inferencing, as input data. Also, assumption will be made that the model parameters have been trained. The search configuration information is information including table names of the tables stored in the DB that is the object of searching, the column names of each of the columns included in each of the tables, and values of the columns.

As illustrated in FIG. 3, at the time of inferencing, the estimating device 10 includes an input processing unit 101, an estimating unit 102, and a comparison determining unit 103. These units are realized by processing that one or more programs installed in the estimating device 10 cause a processor such as a CPU (Central Processing Unit) or the like to execute.

The input processing unit 101 uses the question sentences and the search object configuration information included in the given input data, and creates model input data to be input to the deep learning model that realizes the estimating unit 102. Now the model input data is data expressed in a format of (question sentence, table name of one table stored in the DB that is the object of searching, one column name of this table, and value 1 of this column, . . . , value n of this column). Note that n is the number of values in this column.

The input processing unit 101 creates model input data for all combinations of the question sentences, the table names, and the column names included in the tables of the table names. That is to say, the input processing unit 101 creates a (number of question sentences×number of columns) count of model input data. Note that in a case in which there is a plurality of tables, the number of columns is the total number of columns of all of the tables.

Also, in accordance with the deep learning model that realizes the estimating unit 102, the input processing unit 101 processes the model input data into a format that can be input to this deep learning model.

The estimating unit 102 uses the trained model parameters to estimate, from each model input data created by the input processing unit 101, a two-dimensional vector for determining whether or not a column name included in this model input data is included in the SQL. Note that the model parameters are stored in a storage device such as an HDD (Hard Disk Drive), an SSD (Solid State Drive), or the like, for example.

Now, a detailed functional configuration of the estimating unit 102 will be described with reference to FIG. 4. FIG. 4 is a diagram illustrating an example of the functional configuration of the estimating unit 102 according to Example 1.

As illustrated in FIG. 4, the estimating unit 102 includes a tokenizing unit 111, a general-purpose language model unit 112, and a converting unit 113. At this time, the general-purpose language model unit 112 and the converting unit 113 are realized by a deep learning model including a neural network.

The tokenizing unit 111 performs tokenizing of model input data. Tokenizing is to divide or to section the model input data into increments of tokens (words, or predetermined expressions or phrases).

The general-purpose language model unit 112 is realized by a general-purpose language model such as BERT, RoBERTa, or the like, and inputs model input data following tokenizing and outputs a vector sequence.

The converting unit 113 is realized by a neural network model configured of a linear layer, and an output layer that uses a softmax function as an activation function. The converting unit 113 converts the vector sequence output from the general-purpose language model unit 112 into a two-dimensional vector, and calculates a softmax function value for each element of the two-dimensional vector. Thus, a two dimensional vector, in which each element is no less than 0 and no more than 1, and in which the total of the elements is 1, is obtained.

Returning to FIG. 3, the comparison determining unit 103 compares the magnitude relation of the elements of the two-dimensional vector output from the estimating unit 102, and thereby determines whether or not a relevant column name that corresponds to the SQL for obtaining an answer to the given question sentence is included. The determination results thereof are estimation results indicating whether or not this column name is included in the SQL for obtaining an answer to the question sentence, and are output as output data.

### Estimation Processing (Example 1)

Next, estimation processing according to Example 1 will be described with reference to FIG. 5. FIG. 5 is a flowchart showing an example of estimation processing according to Example 1. Hereinafter, it will be assumed that, as an example, a question sentence “Show the stadium name and the number of concerts in each stadium.” and the search configuration information relating to the DB shown in FIG. 1 and FIG. 2 have been given as input data.

First, the input processing unit 101 inputs the question sentence and the search object configuration information included in the given input data (step S101).

Next, the input processing unit 101 creates model input data from the question sentence and the search object configuration information input in the above step S101 (step S102). Note that a (number of question sentences×number of tables×number of columns) count of model input data is created, as described earlier.

For example, the model input data relating to the table name “stadium” and the column name “Stadium_ID” will be (Show the stadium name and the number of concerts in each stadium., stadium, Stadium_ID, 1, 2, . . . , 10).

In the same way, for example, the model input data relating to the table name “stadium” and the column name “Location” will be (Show the stadium name and the number of concerts in each stadium, stadium, Location, Raith Rovers, Avr United, . . . , Brechin City).

In the same way, for example, the model input data relating to the table name “stadium” and the column name “Name” will be (Show the stadium name and the number of concerts in each stadium., stadium, Name, Stark's Park, Somerset Park, . . . , Glebe Park).

This is also the same for the model input data relating to the other column names of the table name “stadium” (“Capacity”, “Highest”, “Lowest”, and “Average”), and the model input data relating to the column names of the other table names (“concert”, “singer”, and “singer_in_concert”). Thus, a count of 21 (=number of question sentences (=1)×number of columns (=5+7+2+7)) of model input data is created.

Next, the input processing unit 101 processes each of the model input data created in the above step S102 into a format that can be input to the deep learning model that realizes the estimating unit 102 (step S103).

For example, in a case in which the general-purpose language model included in the deep learning model is RoBERTa, the input processing unit 101 inserts a <s> token immediately before the question sentence included in the model input data, and inserts a </s> token at each of immediately after the question sentence, immediately after the table name, immediately after the column names, and immediately after the values of the columns. The input processing unit 101 then imparts 0 as a segment id to each token from the <s> token to the first </s> token, and imparts 1 as a segment id to the other tokens. Note however, that the upper limit of input length that can be input to RoBERTa is 512 tokens, and accordingly in a case in which the model input data following processing exceeds 512 tokens, the input processing unit 101 takes just the 512 tokens from the start as the processed model input data (i.e., the portion exceeding 512 tokens from the start is truncated). Note that the segment id is additional information for clarifying the boundary between sentences, in a case in which the input sequence (token sequence) input to RoBERTa is made up of two sentences and is used in the present embodiment to clarify the boundary between question sentence and table name. The <s> token is a token representing the start of a sentence, and the </s> token is a token representing a section in the sentence or the end of the sentence.

For example, FIG. 6 shows a specific example of input data of this model after processing in a case in which the general-purpose language model included in the deep learning model is RoBERTa, and the model input data is (Show the stadium name and the number of concerts in each stadium., stadium, Name, Stark's Park, Somerset Park, . . . , Glebe Park). As shown in FIG. 6, the <s> token is inserted immediately before the question sentence, and the </s> token is inserted at each of immediately after the question sentence, immediately after the table name, immediately after the column names, and immediately after the values of the columns. Also, 0 is imparted as the segment id to each token from the <s> token to the first </s> token, and 1 as the segment id to each of the other tokens.

Next, the tokenizing unit 111 of the estimating unit 102 tokenizes each of the model input data after processing, obtained in the above step S103 (step S104).

Next, the general-purpose language model unit 112 of the estimating unit 102 uses the trained model parameters to obtain a vector sequence as output, from each of the model input data after tokenizing (step S105). Note that a vector sequence is obtained for each of the model input data. That is to say, in a case in which the count of model input data is 21, for example, 21 vector sequences are obtained.

Next, the converting unit 113 of the estimating unit 102 uses the trained model parameters to convert each in the vector sequence into a two-dimensional vector (step S106). Specifically, with regard to each of the vector sequences, the converting unit 113 converts the start vector (i.e., the vector corresponding to the <s> token) out of the vector sequence into a two-dimensional vector at the linear layer, and calculates a softmax function value at the output layer. Accordingly, in a case in which the count of model input data is 21, for example, 21 two-dimensional vectors are obtained.

The comparison determining unit 103 then determines, by comparing the magnitude of the elements of the two-dimensional vector obtained in the above step S106, whether or not a column name included in the model input data corresponding to this two-dimensional vector (i.e., the model input data input to the deep learning model at the time of this two-dimensional vector being obtained) is included in the SQL (note however, that a case of being included in the SQL as a column name joined by JOIN are excluded), and takes the determination results thereof as estimation results (step S107). Specifically, in a case of expressing the two-dimensional vector by (x, y), for example, the comparison determining unit 103 determines that the column name included in the model input data corresponding to this two-dimensional vector is included in the SQL if x≥y, and determines that the column name included in the model input data corresponding to this two-dimensional vector is not included in the SQL if x<y. Accordingly, estimation results indicating whether or not each of the columns of the DB that is the object of searching is included in the SQL (note however, that cases where joined by JOIN are excluded) are obtained as output data.

### Functional Configuration of Estimating Device 10 at Time of Learning (Example 1)

The functional configuration of the estimating device 10 at the time of learning will be described with reference to FIG. 7. FIG. 7 is a diagram illustrating an example of the functional configuration of the estimating device 10 at the time of learning (Example 1). It will be assumed that question sentences, SQLs, and search object configuration information are given to the estimating device 10 at the time of learning here, as input data. Also, it will be assumed that the model parameters are in the process of learning (i.e., not trained yet).

As illustrated in FIG. 7, the estimating device 10 at the time of learning has the input processing unit 101, the estimating unit 102, a learning data processing unit 104, and an updating unit 105. These units are realized by processing that one or more programs installed in the estimating device 10 cause a processor such as a CPU or GPU (Graphics Processing Unit) or the like to execute. Note that the input processing unit 101 and the estimating unit 102 are the same as at the time of inferencing, and accordingly description thereof will be omitted. Note however, that the estimating unit 102 estimates two-dimensional vectors using model parameters in the process of learning.

The learning data processing unit 104 creates label data correlated with the model input data using the question sentences, the SQLs, and the search object configuration information included in the given input data. Now, label data is data expressed in a format of (question sentence, table name of one table stored in the DB that is the object of searching, one column name of this table, and a label assuming a value of either 0 or 1). The label assumes 1 in a case in which the column name is used in the SQL included in this input data other than by JOIN, and 0 otherwise (i.e., a case of being used by JOIN or not being used in the SQL).

Also, the learning data processing unit 104 correlates the model input data and the label data with the same question sentence, table name, and column name. At the time of learning, updating (learning) of model parameters is performed, deeming the data in which the model input data and the label data are correlated to be training data. Note that the count of model input data created by the input processing unit 101 and the count of label data created by the learning data processing unit 104 are equal (e.g., a count of (number of question sentences×number of columns)).

The updating unit 105 updates the model parameters by a known optimization technique, using the loss (error) between the two-dimensional vector estimated by the estimating unit 102 and a correct vector representing the label included in the label data corresponding to the model input data input to the estimating unit 102 at the time of inferencing this two-dimensional vector. The correct vector here is a vector that is (0, 1) in a case in which the value of the label is 0, and is (1, 0) in a case in which the value of the label is 1, for example.

### Learning Processing (Example 1)

Next, the learning processing according to Example 1 will be described with reference to FIG. 8. FIG. 8 is a flowchart showing an example of learning processing according to Example 1. Hereinafter, it will be assumed that, as an example, a question sentence “Show the stadium name and the number of concerts in each stadium.”, and SQL “SELECT T2.Name, count(*) FROM concert AS T1 JOIN stadium AS T2 ON T1. Stadium_id=T2.Stadium_id GROUP BY T1. Stadium_id”, and the search configuration information relating to the DB shown in FIG. 1 and FIG. 2, have been given as input data.

Step S201 through step S203 are each the same as step S101 through step S103 in FIG. 5, and accordingly description thereof will be omitted.

Following step S203, the learning data processing unit 104 inputs the question sentence, the SQL, and the search object configuration information that are included in the given input data (step S204).

Next, the learning data processing unit 104 creates label data from the question sentence, the SQL, and the search object configuration information input in step S204 above (step S205). Note that label data of the same count as the model input data is created, as described above.

For example, label data relating to the table name “stadium” and the column name “Stadium_ID” will be (Show the stadium name and the number of concerts in each stadium., stadium, Stadium_ID, 0). This is because the Stadium_ID column in the stadium table is used by JOIN in the SQL, and the value of the label is 0.

In the same way, for example, label data relating to the table name “stadium” and the column name “Location” will be (Show the stadium name and the number of concerts in each stadium., stadium, Location, 0). This is because the Location column in the stadium table is not used in the SQL, and the value of the label is 0.

Conversely, for example, label data relating to the table name “stadium” and the column name “Name” will be (Show the stadium name and the number of concerts in each stadium., stadium, Name, 1). This is because the Name column in the stadium table is used in the SQL by other than JOIN, and the value of the label is 1.

This is also the same for the label data relating to the other column names of the table name “stadium” (“Capacity”, “Highest”, “Lowest”, and “Average”), and the label data relating to the column names of the other table names (“concert”, “singer”, and “singer_in_concert”). Thus, a count of 21 (=number of question sentences (=1)×number of columns (=5+7+2+7)) of label data is created.

Next, the learning data processing unit 104 correlates the model input data and the label data with the same question sentence, table name, and column name, as training data, and creates a training dataset configured of the training data (step S206). This yields a training dataset configured of a (number of question sentences×number of columns) count of training data.

Subsequently, the estimating device 10 at the time of learning executes parameter updating processing using the training dataset and learns (updates) the model parameters (step S207). The parameter updating processing according to Example 1 will be described here with reference to FIG. 9. FIG. 9 is a flowchart showing an example of parameter updating processing according to Example 1. Description will be made hereinafter regarding a case of updating the model parameters by minibatch learning in which the batch size is m, as an example. Note however, that other optional techniques, such as online learning, batch learning and so forth, may be used for updating the model parameters, for example.

First, the updating unit 105 selects an m count of training data from the training dataset created in the above step S206 (step S301). Note that m is the batch size, and can be set to an optional value. For example, in a case in which the training dataset is configured of a 21 count of training data, m=8 or the like is conceivable.

Next, the input processing unit 101 processes each of the m count of model input data included in each of the m count of training data into a format that can be input to the deep learning model that realizes the estimating unit 102 (step S302), in the same way as in step S103 in FIG. 5.

Next, the tokenizing unit 111 of the estimating unit 102 tokenizes each of the m count of model input data after processing, obtained in the above step S302 (step S303), in the same way as in step S104 in FIG. 5.

Next, the general-purpose language model unit 112 of the estimating unit 102 uses the model parameters in the process of learning to obtain m vector sequences, as output from each of the m count of model input data after tokenizing (step S304).

Next, the converting unit 113 of the estimating unit 102 converts each of the m vector sequences into m two-dimensional vectors, using the model parameters in the process of learning (step S305).

Next, the updating unit 105 takes the sum of loss between the m two-dimensional vectors obtained in the above step S305 and m correct vectors corresponding to each of these m two-dimensional vectors as a loss function value, and calculates a gradient regarding this loss function value and the model parameters (step S306). Note that while any function that represents loss or error among vectors can be used as the loss function, cross entropy or the like can be used, for example. Also, the correct vectors are each a vector that is (0, 1) in a case in which the label value of the label data corresponding to the model input data input to the estimating unit 102 at the time of inferencing the two-dimensional vector is 0, and is (1, 0) in a case in which the label value is 1, as described above.

The updating unit 105 then updates the model parameters by a known optimization technique, using the loss function value and the gradient thereof calculated in the above step S307 (step S307). Note that while any technique can be used for the optimization technique, using Adam or the like, for example, is conceivable.

Subsequently, the updating unit 105 determines whether or not there is unselected training data in the training dataset (Step S308). In a case in which determination is made that there is unselected training data, the updating unit 105 returns to step S301. Accordingly, an unselected m count of training data is selected in the above step S301, and the above step S302 through step S307 are executed. Note that in a case in which the count of unselected training data is no less than 1 and less than m, an arrangement may be made in which all of the unselected training data is selected in the above step S301, or an arrangement may be made in which the count of training data in the training dataset is made in advance to be a multiple of m, by a known data augmentation technique or the like.

Conversely, in a case in which determination is made that there is no unselected training data, the updating unit 105 determines whether or not predetermined ending conditions are satisfied (step S309). Note that examples of ending conditions include that the model parameters have converged, the number of times of repetition of step S301 through step S308 has reached a predetermined number of times or more, and so forth.

In a case in which determination is made that the predetermined ending conditions are satisfied, the estimating device 10 ends the parameter updating processing. Accordingly, the model parameters of the deep learning model that the estimating unit 102 realizes are learned.

Conversely, in a case in which determination is made that the predetermined ending conditions are not satisfied, the updating unit 105 sets all training data in the training dataset to unselected (step S310), and returns to the above step S301. Accordingly, the m count of training data is selected again in the above step S301, and the above step S302 and thereafter is executed.

### EXAMPLE 2

In Example 2, an estimating device 20 that realizes the task indicated in (2) above (i.e., the task of estimating whether or not two column names in an SQL for obtaining an answer to the Question sentence are joined by JOIN), by a deep learning model, will be described. Note that with regard to the estimating device 20, there is a time of learning in which model parameters are learned, and there is a time of inferencing in which estimation is performed regarding whether or not two column names in an SQL for obtaining an answer to the given question sentence are joined by JOIN, by a deep learning model in which trained model parameters are set. Note that at the time of learning, the estimating device 20 may be referred to as a “learning device” or the like.

### Functional Configuration of Estimating Device 20 at Time of Inferencing (Example 2)

The functional configuration of the estimating device 20 at the time of inferencing will be described with reference to FIG. 10. FIG. 10 is a diagram illustrating an example of the functional configuration of the estimating device 20 at the time of inferencing (Example 2). Here, assumption will be made that question sentences and search object configuration information are given to the estimating device 20 at the time of inferencing, as input data, in the same way as in Example 1. Also, assumption will be made that the model parameters have been trained.

As illustrated in FIG. 10, at the time of inferencing, the estimating device 20 includes an input processing unit 101A, the estimating unit 102, and the comparison determining unit 103. These units are realized by processing that one or more programs installed in the estimating device 20 cause a processor to execute. Note that the estimating unit 102 and the comparison determining unit 103 are the same as in Example 1, and accordingly description thereof will be omitted. It should also be noted that the two-dimensional vector estimated by the estimating unit 102 is a vector for determining whether or not two column names in the SQL for obtaining an answer to the given question sentence are joined by JOIN.

The input processing unit 101A uses the question sentences and the search object configuration information included in the given input data, and creates model input data expressed in a format of (question sentence, table name of a first table stored in the DB that is the object of searching, a first column name of this first table, and value 1 of this first column, . . . , value n₁ of this first column, table name of a second table stored in this DB, a second column name of this second table, and value 1 of this second column, . . . , value n₂ of this second column). Note that n₁ is the number of values in the first column, and n₂ is the number of values in the second column.

The input processing unit 101A creates model input data for combinations of the question sentences, the first table name, the column names included in the table of the first table name, the second table name, and the column names included in the table of the second table name. That is to say, the input processing unit 101A creates a (number of question sentences×a count of combinations of first table name and first column names, and second table name and second column names) count of model input data.

Also, in accordance with the deep learning model that realizes the estimating unit 102, the input processing unit 101A processes the model input data into a format that can be input to this deep learning model.

### Estimation Processing (Example 2)

Next, estimation processing according to Example 2 will be described with reference to FIG. 11. FIG. 11 is a flowchart showing an example of estimation processing according to Example 2. Hereinafter, it will be assumed that, as an example, a question sentence “Show the stadium name and the number of concerts in each stadium.” and the search configuration information relating to the DB shown in FIG. 1 and FIG. 2 have been given as input data.

First, the input processing unit 101A inputs the question sentence and the search object configuration information included in the given input data (step S401).

Next, the input processing unit 101A creates model input data from the question sentence and the search object configuration information input in the above step S401 (step S402). Note that a (number of question sentences×a count of combinations of first table name and first column names, and second table name and second column names) count of model input data is created, as described above.

For example, the model input data relating to the table name “stadium” and the column name “Stadium_ID”, and the table name “concert” and the column name “concert_ID”, will be (Show the stadium name and the number of concerts in each stadium., stadium, Stadium_ID, 1, 2, . . . , 10, concert, Concert_ID, 1, 2, . . . , 6).

In the same way, for example, the model input data relating to the table name “stadium” and the column name “Stadium_ID”, and the table name “concert” and the column name “Concert_Name”, will be (Show the stadium name and the number of concerts in each stadium., stadium, Stadium_ID, 1, 2, . . . , 10, concert, Concert_Name, Auditions, Super bootcamp, . . . , Week).

In the same way, for example, the model input data relating to the table name “stadium” and the column name “Stadium_ID”, and the table name “concert” and the column name “Theme”, will be (Show the stadium name and the number of concerts in each stadium., stadium, Stadium_ID, 1, 2, . . . , 10, concert, Theme, Free choice, Free choice2, . . . , Party All Night).

This is also the same for model input data of other combinations of the first table name and the first column name, and the second table name and the second column name. Thus, a count of 157 (=number of question sentences (=1)×combinations of the first table name and the first column name, and the second table name and the second column name (=35+10+35+14+49+14)) of model input data is created. It should be noted, however, that model input data may be created in which a combination of (first table name, second table name) and a combination of (second table name, first table name) are distinguished.

Next, the input processing unit 101A processes each of the model input data created in the above step S402 into a format that can be input to the deep learning model that realizes the estimating unit 102 (step S403), in the same way as in step S103 in FIG. 5.

For example, FIG. 12 shows a specific example of input data of this model after processing in a case in which the general-purpose language model included in the deep learning model is RoBERTa, and the model input data is (Show the stadium name and the number of concerts in each stadium., stadium, Name, Stark's Park, Somerset Park, . . . , Glebe Park, concert, Year, 2014, 2014, . . . , 2015). As shown in FIG. 12, the <s> token is inserted immediately before the question sentence, and the </s> token is inserted at each of immediately after the question sentence, immediately after the table names, immediately after the column names, and immediately after the values of the columns. Also, 0 is imparted as the segment id to each token from the <s> token to the first </s> token, and 1 as the segment id to each of the other tokens. Note however, that in a case in which the upper limit of the input length that can be input to RoBERTa (512 tokens) is exceeded, the tokens representing the values of the two columns are each deleted, so that the model input data following processing is 512 tokens.

Next, the tokenizing unit 111 of the estimating unit 102 tokenizes each of the model input data after processing, obtained in the above step S403 (step S404), in the same way as in step S104 in FIG. 5.

The general-purpose language model unit 112 of the estimating unit 102 uses the trained model parameters to obtain a vector sequence as output, from each of the model input data after tokenizing (step S405), in the same way as in step S105 in FIG. 5.

Next, the converting unit 113 of the estimating unit 102 uses the trained model parameters to convert each in the vector sequence into a two-dimensional vector (step S406), in the same way as in step S106 in FIG. 5.

The comparison determining unit 103 then determines, by comparing the magnitude of the elements of the two-dimensional vector obtained in the above step S406, whether or not two column names included in the model input data corresponding to this two-dimensional vector are joined by JOIN in the SQL, and takes the determination results thereof as estimation results (step S407). Specifically, in a case of expressing the two-dimensional vector by (x, y), for example, the comparison determining unit 103 determines that two column names included in the model input data corresponding to this two-dimensional vector are joined by JOIN in the SQL if x≥y, and determines that two column names included in the model input data corresponding to this two-dimensional vector are not joined by JOIN in the SQL if x<y. Accordingly, estimation results indicating whether or not joined by JOIN in the SQL are obtained, regarding all combinations of two column names out of the column names of the DB that is the object of searching, as output data.

### Functional Configuration of Estimating Device 20 at Time of Learning (Example 2)

The functional configuration of the estimating device 20 at the time of learning will be described with reference to FIG. 13. FIG. 13 is a diagram illustrating an example of the functional configuration of the estimating device 20 at the time of learning (Example 2). It will be assumed here that question sentences, SQLs, and search object configuration information are given to the estimating device 20 at the time of learning, as input data. Also, it will be assumed that the model parameters are in the process of learning.

As illustrated in FIG. 13, the estimating device 20 at the time of learning has the input processing unit 101A, the estimating unit 102, a learning data processing unit 104A, and the updating unit 105. These units are realized by processing that one or more programs installed in the estimating device 20 cause a processor to execute. Note that the input processing unit 101A and the estimating unit 102 are the same as at the time of inferencing, and the updating unit 105 is the same as in Example 1, and accordingly description thereof will be omitted. Note however, that the estimating unit 102 estimates two-dimensional vectors using model parameters in the process of learning.

The learning data processing unit 104A creates label data using the question sentences, the SQLs, and the search object configuration information included in the given input data, expressed in a format of (question sentence, table name of first table that is stored in the DB that is the object of searching, first column name of the first table, table name of the second table that is stored in this DB, second column name of the second table, and a label assuming a value of either 0 or 1). The label assumes 1 in a case in which the first column name and the second column name are joined by JOIN in the SQL included in the input data, and 0 otherwise (i.e., a case of being used by other than JOIN or not being used in the SQL).

Also, the learning data processing unit 104A correlates the model input data and the label data with the same question sentence, first table name, first column name, second table name, and second column name. Note that the count of model input data created by the input processing unit 101 and the count of label data created by the learning data processing unit 104 are equal.

### Learning Processing (Example 2)

Next, the learning processing according to Example 2 will be described with reference to FIG. 14. FIG. 14 is a flowchart showing an example of learning processing according to Example 2. Hereinafter, it will be assumed that, as an example, a question sentence “Show the stadium name and the number of concerts in each stadium.”, and SQL “SELECT T2.Name, count(*) FROM concert AS T1 JOIN stadium AS T2 ON T1.Stadium_id=T2.Stadium_id GROUP BY T1.Stadium_id”, and the search configuration information relating to the DB shown in FIG. 1 and FIG. 2, have been given as input data.

Step S501 through step S503 are each the same as step S401 through step S403 in FIG. 11, and accordingly description thereof will be omitted.

Following step S503, the learning data processing unit 104A inputs the question sentence, the SQL, and the search object configuration information that are included in the given input data (step S504).

Next, the learning data processing unit 104A creates label data from the question sentence, the SQL, and the search object configuration information input in step S504 above (step S505). Note that label data of the same count as the model input data is created, as described above.

For example, label data relating to the table name “stadium” and the column name “Stadium_ID”, and the table name “concert” and the column name “Stadium_ID”, will be (Show the stadium name and the number of concerts in each stadium., stadium, Stadium_ID, concert, Stadium_ID, 1). This is because the Stadium_ID column in the stadium table and the Stadium_ID column in the concert table are joined by JOIN in the SQL, and the value of the label is 1.

Conversely, for example, label data relating to the table name “stadium” and the column name “Stadium_ID”, and the table name “concert” and the column name “Year” will be (Show the stadium name and the number of concerts in each stadium., stadium, Stadium_ID, concert, Year, 0).

This is also the same for the label data relating to the other combinations of first table name and first column name, and second table name and second column name. Thus, a count of label data equal to that of the model input data is created.

Next, the learning data processing unit 104A correlates the model input data and the label data by the table name and the column name to yield training data, in the same way as in step S206 in FIG. 8, and creates a training dataset configured of the training data (step S506).

Subsequently, the estimating device 20 at the time of learning executes parameter updating processing using the training dataset and learns (updates) the model parameters (step S507). The parameter updating processing according to Example 2 will be described here with reference to FIG. 15. FIG. 15 is a flowchart showing an example of parameter updating processing according to Example 2. Description will be made hereinafter regarding a case of updating the model parameters by minibatch learning in which the batch size is m in the same way as with Example 1, as an example.

First, the updating unit 105 selects an m count of training data from the training dataset created in the above step S506 (step S601).

Next, the input processing unit 101 processes each of the m count of model input data included in each of the m count of training data into a format that can be input to the deep learning model that realizes the estimating unit 102 (step S602), in the same way as in step S403 in FIG. 11.

The subsequent step S603 through step S610 are the same as step S303 through step S310 in FIG. 9, respectively, and accordingly description thereof will be omitted.

### EXAMPLE 3

In Example 3, an estimating device 30 that realizes a task of estimating an SQL for obtaining an answer to a given question sentence (i.e., a text to SQL task that also takes into consideration the values of the columns of the DB), by a deep learning model, using the estimation results of the task shown in (1) above and the estimation results of the task shown in (2) above, will be described. Note that in Example 3, the deep learning model that estimates the SQL will be referred to as “SQL estimation model”, and the parameters thereof will be referred to as “SQL estimation model parameters”. With regard to the estimating device 30 here, there is a time of learning in which the SQL estimation model parameters are learned, and there is a time of inferencing in which an SQL is estimated to obtain an answer to the given question sentence, by an SQL estimation model in which trained SQL estimation model parameters are set. Note that at the time of learning, the estimating device 30 may be referred to as a “learning device” or the like.

### Functional Configuration of Estimating Device 30 at Time of Inferencing (Example 3)

The functional configuration of the estimating device 30 at the time of inferencing will be described with reference to FIG. 16. FIG. 16 is a diagram illustrating an example of the functional configuration of the estimating device 30 at the time of inferencing (Example 3). Here, assumption will be made that question sentences and search object configuration information are given to the estimating device 30 at the time of inferencing, as input data. Also, assumption will be made that the SQL estimation model parameters have been trained.

As illustrated in FIG. 16, at the time of inferencing, the estimating device 30 includes an input processing unit 106 and an SQL estimating unit 107. These units are realized by processing that one or more programs installed in the estimating device 30 cause a processor to execute.

The input processing unit 106 uses the question sentences and the search object configuration information included in the given input data, the output data of the estimating device 10 as to this input data, and the output data of the estimating device 20 as to this input data, and creates model input data to be input to the SQL estimation model that realizes the SQL estimating unit 107. Now, the model input data is data in which information indicating the estimation results by the estimating device 10 and the estimating device 20 is added to tokens representing the column names included in the data input to a known SQL estimation model. For example, this data is data in which, out of tokens representing the column names included in the data input to a known SQL estimation model, [unused0] is imparted to tokens representing column names used by other than JOIN in the SQL, and [unused1] is imparted to tokens representing column names used by JOIN in the SQL. Regarding the tokens representing the column names, whether or not to impart [unused0] is decided by estimation results included in the output data from the estimating device 10, and whether or not to impart [unused1] is decided by estimation results included in the output data from the estimating device 20.

Note that the estimating device 10 and the estimating device 20 are each assumed to have been trained. Also, the estimating device 10 and the estimating device 20 (or functional portions thereof) may be assembled into the estimating device 30, or may be connected to the estimating device 30 via a communication network or the like.

The SQL estimating unit 107 estimates an

SQL to obtain an answer to the given Question sentence, from the model input data created by the input processing unit 106, using trained SQL estimation model parameters. An SQL representing the estimating results thereof is output as output data. Note that the SQL estimating unit 107 is realized by an SQL estimation model. Examples of such an SQL estimation model include an Edit SQL model described in the above NPL 1, and so forth.

### Estimation Processing (Example 3)

Next, estimation processing according to Example 3 will be described with reference to FIG. 17. FIG. 17 is a flowchart showing an example of estimation processing according to Example 3. Hereinafter, it will be assumed that, as an example, a question sentence “Show the stadium name and the number of concerts in each stadium.” and the search configuration information relating to the DB shown in FIG. 1 and FIG. 2 have been given as input data.

The estimating device 10 executes step S101 through step S107 in FIG. 5, and obtains output data including estimation results indicating whether or not each column name in the DB is used by other than JOIN in the SQL (step S701). Hereinafter, these estimation results will be referred to as “task 1 estimation results”. The task 1 estimation results are an arrangement in which each column name is correlated with information indicating whether or not that column name is used by other than JOIN in the SQL, for example.

The estimating device 20 executes step S401 through step S407 in FIG. 11, and obtains output data including estimation results indicating whether or not a combination of two column names in the DB is joined by JOIN in the SQL (step S702). Hereinafter, these estimation results will be referred to as “task 2 estimation results”. The task 2 estimation results are an arrangement in which a combination of two column names is correlated with information indicating whether or not that combination is used by JOIN in the SQL, for example.

Next, the input processing unit 106 inputs the question sentence and the search object configuration information included in the given input data, the task 1 estimation results, and the task 2 estimation results (step S703).

Next, the input processing unit 106 creates model input data from the question sentence, the search object configuration, the task 1 estimation results, and the task 2 estimation results, input in the above step S703 (step S704).

Now, in a case in which the SQL estimation model is the Edit SQL model, for example, the Edit SQL model has BERT embedded therein, and accordingly, with [CLS]question sentence[SEP]table name1.column name 1_1 [SEP] . . . [SEP]table name 1.column name 1_N₁ [SEP] . . . [SEP]table name k.column name k_1 [SEP] . . . [SEP]table name k.column name k_Nₖ [SEP], an arrangement in which 0 is imparted as the segment id for each token from the [CLS] to the first [SEP], and 1 is imparted as the segment id to each of the other tokens, is input to the SQL estimation model. Note that Nᵢ (i=1, . . . , k) is the number of columns included in the table of table name i.

Accordingly, in this case, the input processing unit 106 uses the task 1 estimation results and the task 2 estimation results to add [unused0] immediately after tokens representing column names used by other than JOIN in the SQL, and to add [unused1] immediately after tokens representing column names used by JOIN in the SQL, thereby creates the model input data. Note that [unused0] and [unused1] are unknown tokens not learned in advance by BERT.

Specifically, in a case in which the Name column of the stadium table is used in the SQL by other than JOIN, and the Stadium_ID column of the concert table and the Stadium_ID column of the stadium table are used in this SQL by JOIN, for example, the model input data will be an arrangement in which, with [CLS] Show the stadium name and the number of concerts in each stadium. [SEP] concert.Concert_ID[SEP] . . . [SEP] concert .Stadium_ID.[unused1] [SEP] concert.Year [SEP] . . . [SEP] stadium. Stadium_ID[unused1] [SEP] . . . [SEP] stadium.Nam e [unused0] [SEP] . . . [SEP] stadium.Average [SEP], 0 is imparted as the segment id for each token from the [CLS] to the first [SEP], and 1 is imparted as the segment id to each of the other tokens.

Next, the SQL estimating unit 107 uses the trained SQL estimation model parameters and estimates the SQL from the model input data obtained in the above step S704 (step S705). Accordingly, the SQL that also takes the values of each column in the DB into consideration is estimated, and the estimation results thereof are obtained as output data. At this time, due to the SQL being estimated taking into consideration values of the columns of the DB as well, estimation of an SQL to obtain an answer to a question sentence that requires taking into consideration values of the columns of the DB can be performed with high precision, for example.

### Functional Configuration of Estimating Device 30 at Time of Learning (Example 3)

The functional configuration of the estimating device 30 at the time of learning will be described with reference to FIG. 18. FIG. 18 is a diagram illustrating an example of the functional configuration of the estimating device 30 at the time of learning (Example 3). It will be assumed here that question sentences, SQLs, and search object configuration information are given to the estimating device 30 at the time of learning, as input data. Also, it will be assumed that the SQL estimation model parameters are in the process of learning.

As illustrated in FIG. 18, the estimating device 30 at the time of learning has the input processing unit 106, the SQL estimating unit 107, and an SQL estimation model updating unit 108. These units are realized by processing that one or more programs installed in the estimating device 30 cause a processor to execute. Note that the input processing unit 106 and the SQL estimating unit 107 are the same as at the time of inferencing, and accordingly description thereof will be omitted. Note however, that the SQL estimating unit 107 estimates the SQL using SQL estimation model parameters in the process of learning.

The SQL estimation model updating unit 108 updates the SQL estimation model parameters by a known optimization technique, using loss (error) between the SQL estimated by the SQL estimating unit 107 and the SQL included in the input data (hereinafter referred to as “correct SQL”).

### Learning Processing (Example 3)

Next, the learning processing according to Example3 will be described with reference to FIG. 19. FIG. 19 is a flowchart showing an example of learning processing according to Example 3. Hereinafter, it will be assumed that, as an example, a question sentence “Show the stadium name and the number of concerts in each stadium.”, and correct SQL “SELECT T2.Name, count(*) FROM concert AS T1 JOIN stadium AS T2 ON T1.Stadium_id=T2. Stadium_id GROUP BY T1.Stadium_id”, and the search configuration information relating to the DB shown in FIG. 1 and FIG. 2, have been given as input data.

Step S801 through step S804 are each the same as step S701 through step S704 in FIG. 17, and accordingly description thereof will be omitted.

Following step S804, the SQL estimating unit 107 estimates the SQL from the model input data obtained in the above step S804, using the SQL estimation model parameters in the process of learning (step S805).

Subsequently, the SQL estimation model updating unit 108 updates the SQL estimation model parameters by a known optimization technique, using the loss between the SQL estimated in the above step S805 and the correct SQL (step S806). Thus, the SQL estimation model parameters are learned. Note that generally, the estimating device 30 at the time of learning is often given a plurality of input data as a training dataset. In such cases, the SQL estimation model parameters can be learned by minibatch learning, batch learning, online learning, or the like.

### Evaluation Experiment

Next, the results of performing an evaluation experiment of the task in the above (1) and the task in the above (2) using the Spider dataset will be described. Regarding the Spider dataset, refer to reference literature “Tao Yu, Rui Zhang, Kai Yang, Michihiro Yasunaga, Dongxu Wang, Zifan Li, James Ma, Irene Li, Qingning Yao, Shanelle Roman, Zilin Zhang, Dragomir Radev, ‘Spider: A Large-Scale Human-Labeled Dataset for Complex and Cross-Domain Semantic Parsing and Text-to-SQL Task’, arXiv:1809.08887 [cs.CL] 2 Feb. 2019” and so forth, for example.

In the Spider dataset, 10181 sets of data expressed by (question sentence, configuration information of DB that is the object of searching, answer to the question sentence, SQL for obtaining this answer) are given. Out of these, 1034 sets were used as verification data, and the remaining 9144 sets were used as training data.

### Experiment Results of Task Shown in the Above (1)

In a Base experiment to serve as a comparison example, the model input data input to the estimating unit 102 was data expressed in a format of (question sentence, table name of one table stored in the DB that is the object of searching, one column name of this table). That is to say, the values of the column were not included in the model input data. Other conditions were the same as those of the estimating device 10 at the time of inferencing.

At this time, the F1 measure of the estimating device 10 at the time of inferencing was 0.825, and the F1 measure of the Base was 0.791. Accordingly, it can be understood that whether or not each of the column names other than column names joined by JOIN are included in the SQL can be estimated with high precision by taking the values of the columns of the DB into consideration.

### Experiment Results of Task Shown in the Above (2)

In a Base experiment to serve as a comparison example, the model input data input to the estimating unit 102 was (question sentence, table name of first table stored in the DB that is the object of searching, column name of first column in the first table, table name of second table stored in this DB, column name of second column in the second table). That is to say, the values of the column were not included in the model input data. Other conditions were the same as those of the estimating device 20 at the time of inferencing.

At this time, the F1 measure of the estimating device 20 at the time of inferencing was 0.943, and the F1 measure of the Base was 0.844. Accordingly, it can be understood that whether or not two column names are joined by JOIN in the SQL can be estimated with high precision by taking the values of the columns of the DB into consideration.

### Hardware Configuration

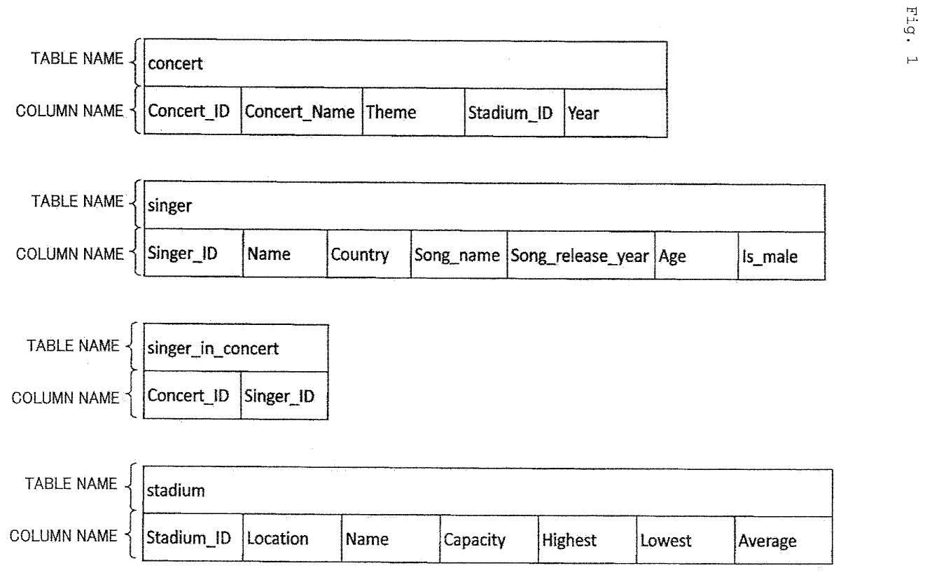

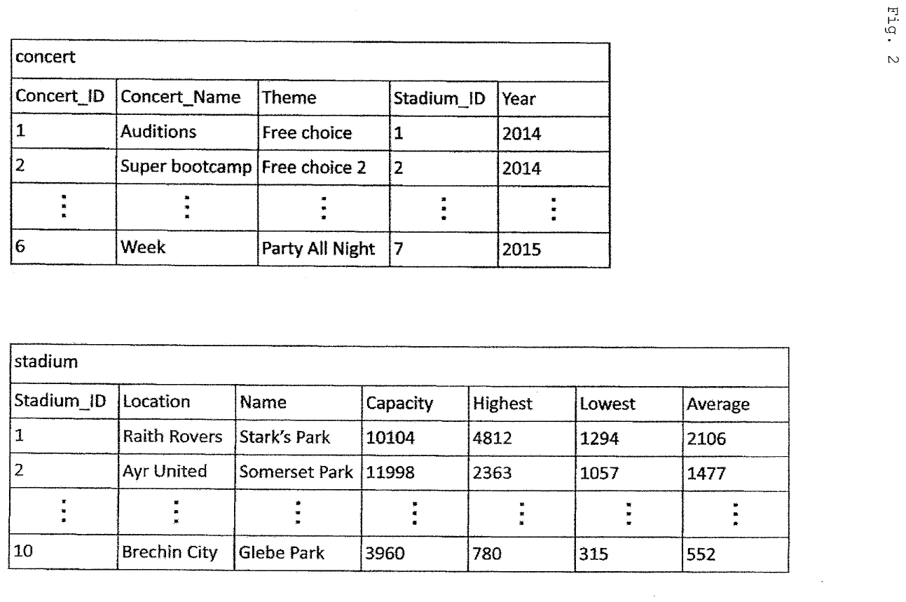

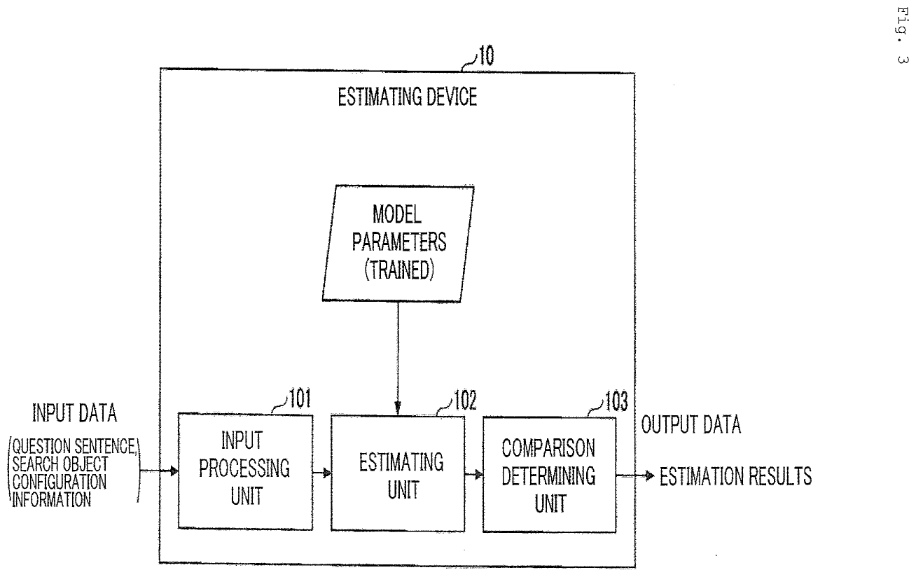

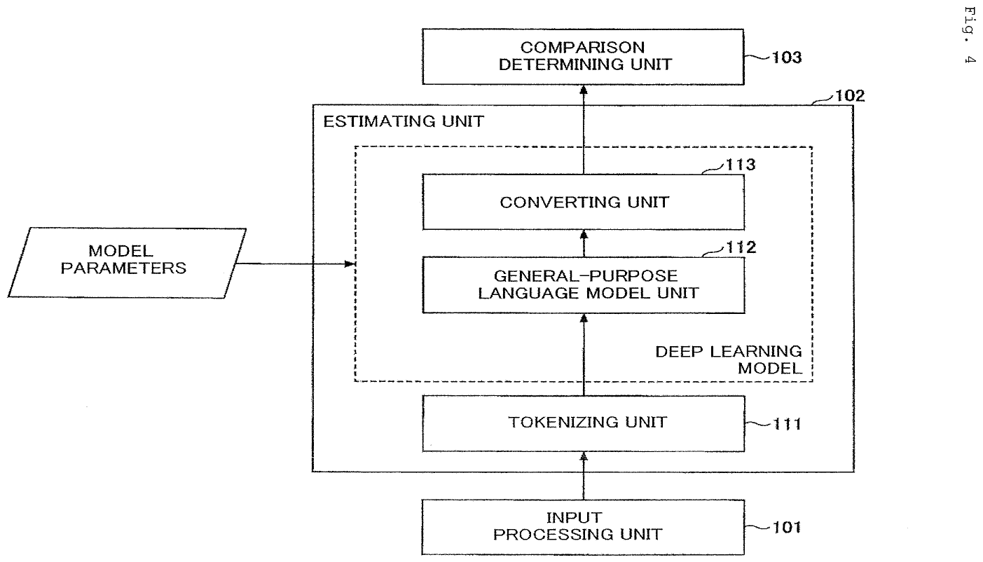

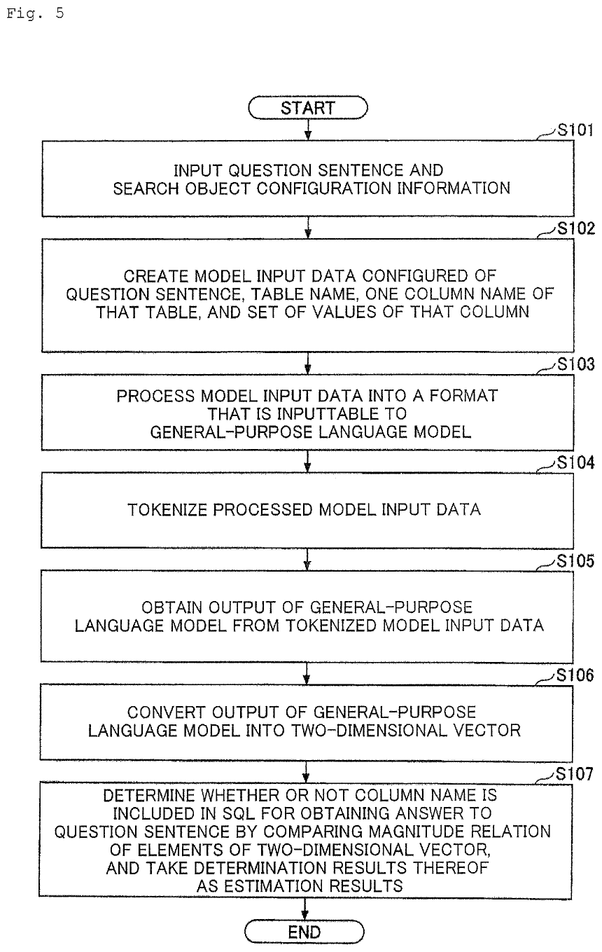

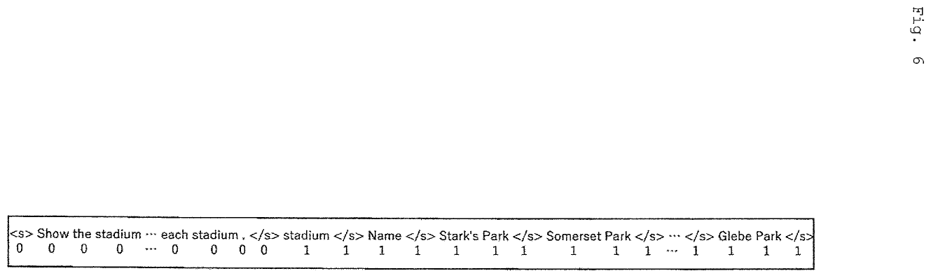

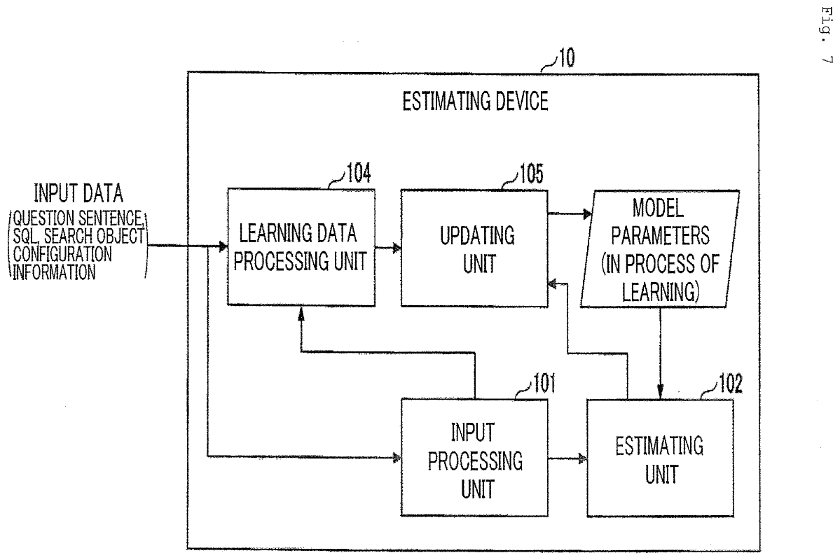

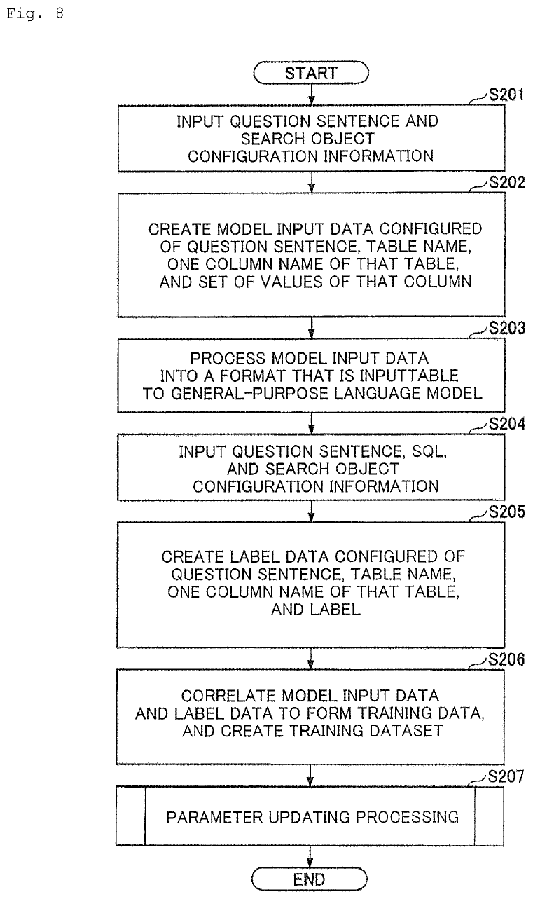

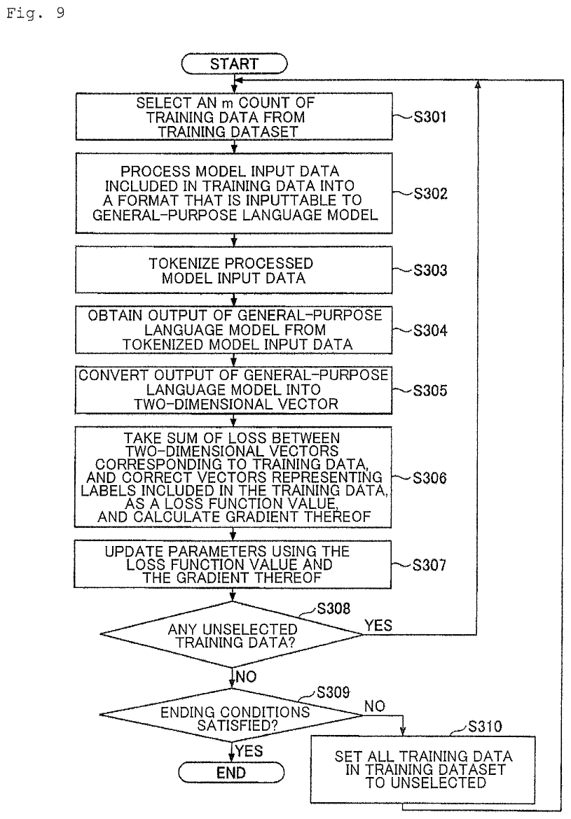

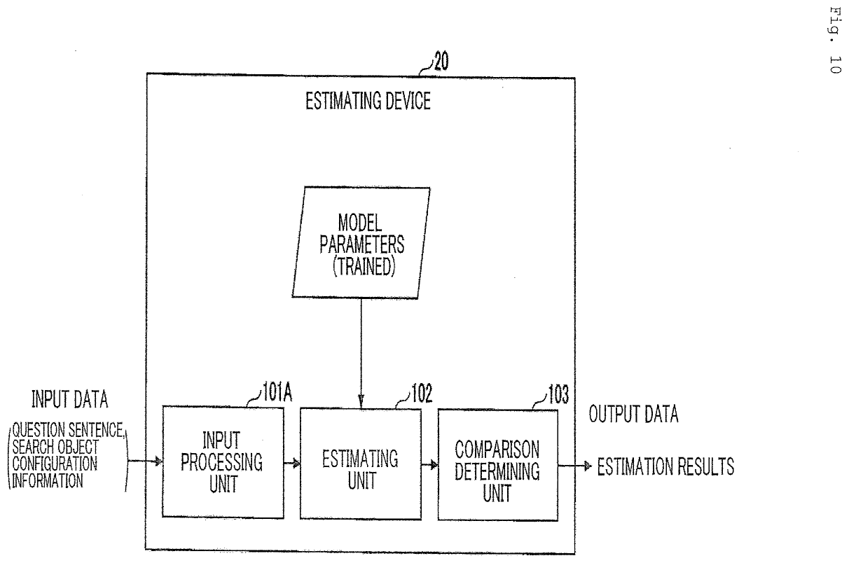

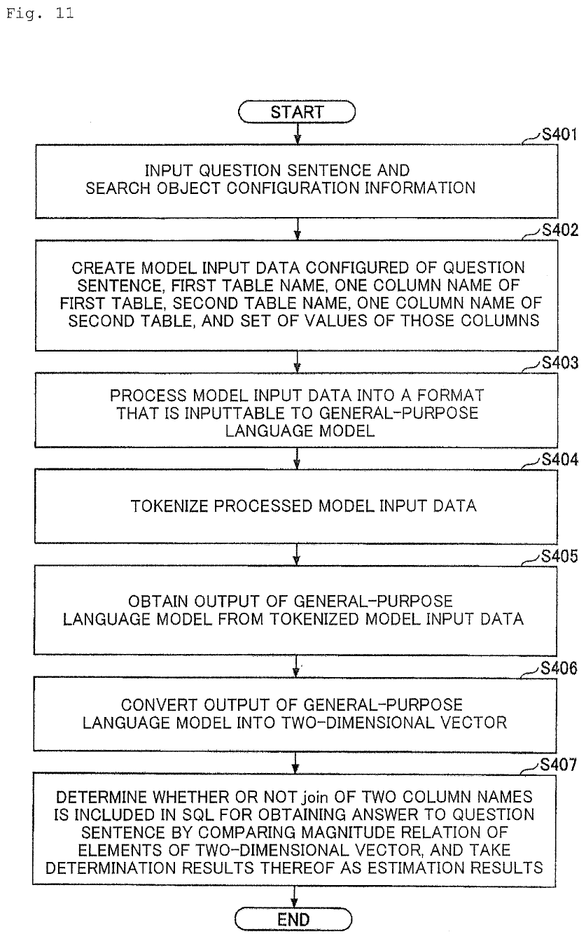

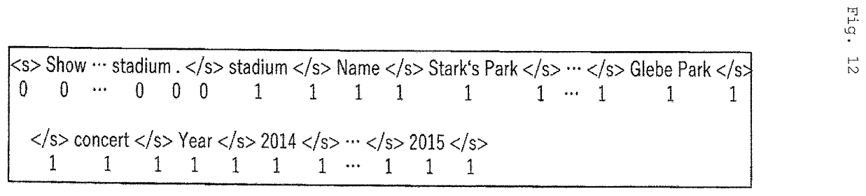

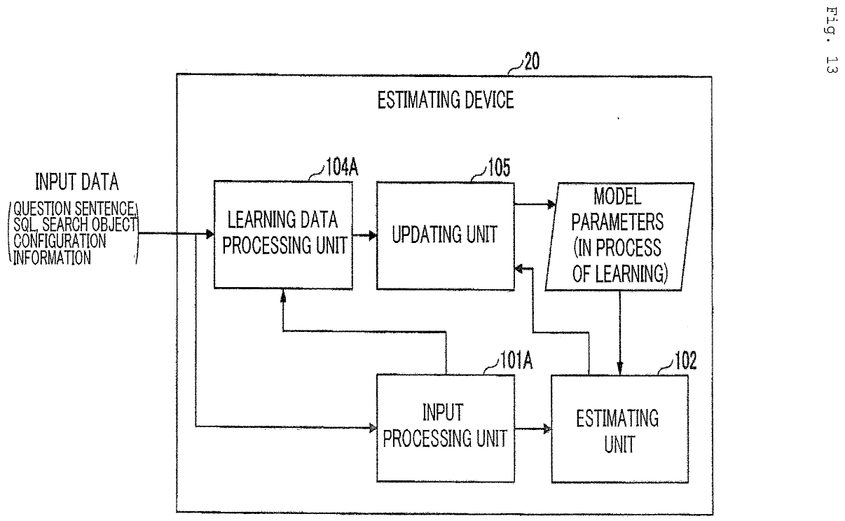

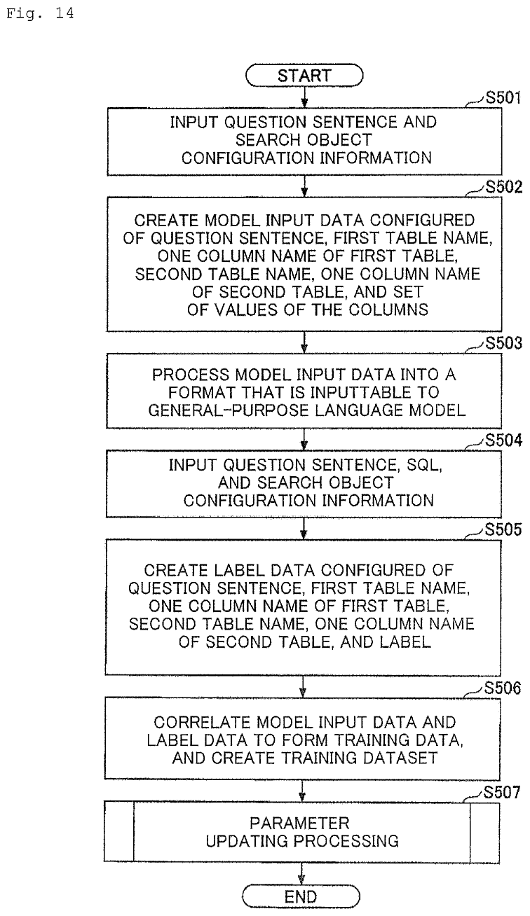

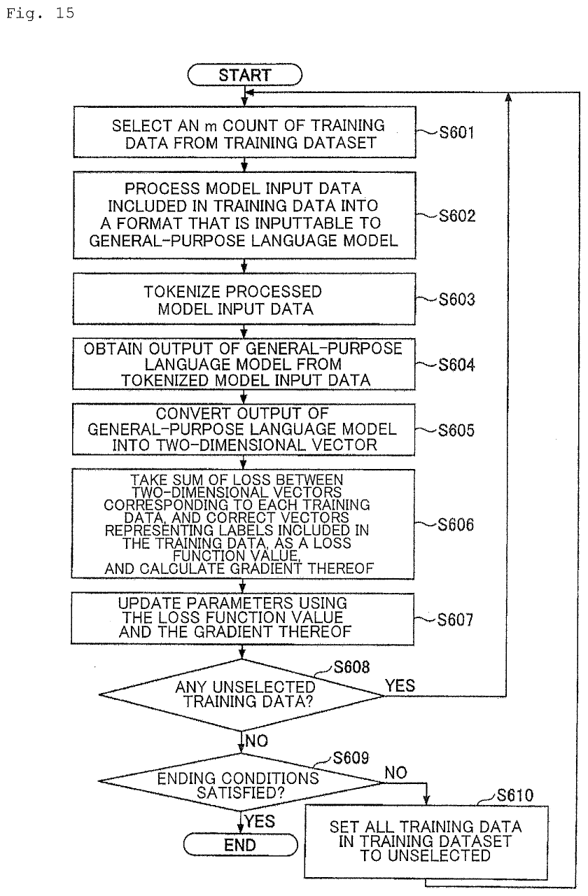

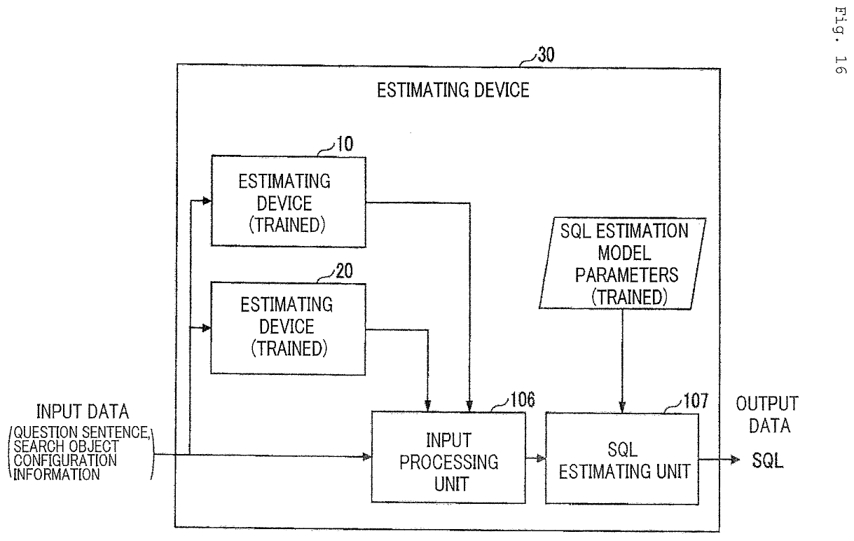

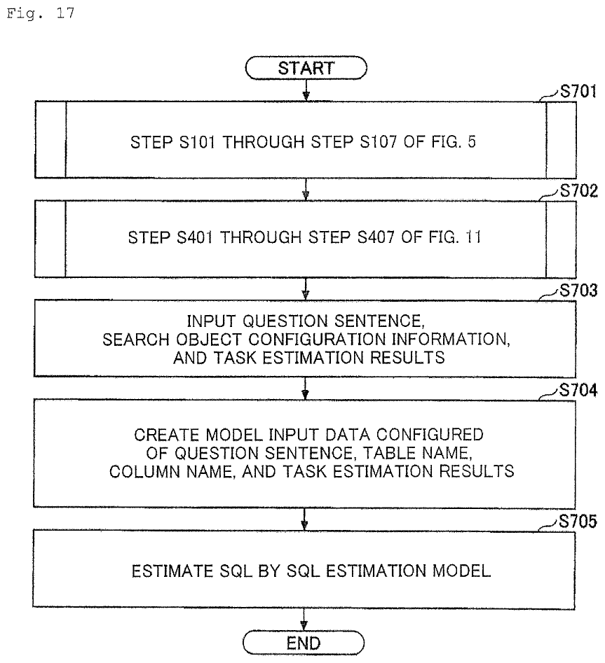

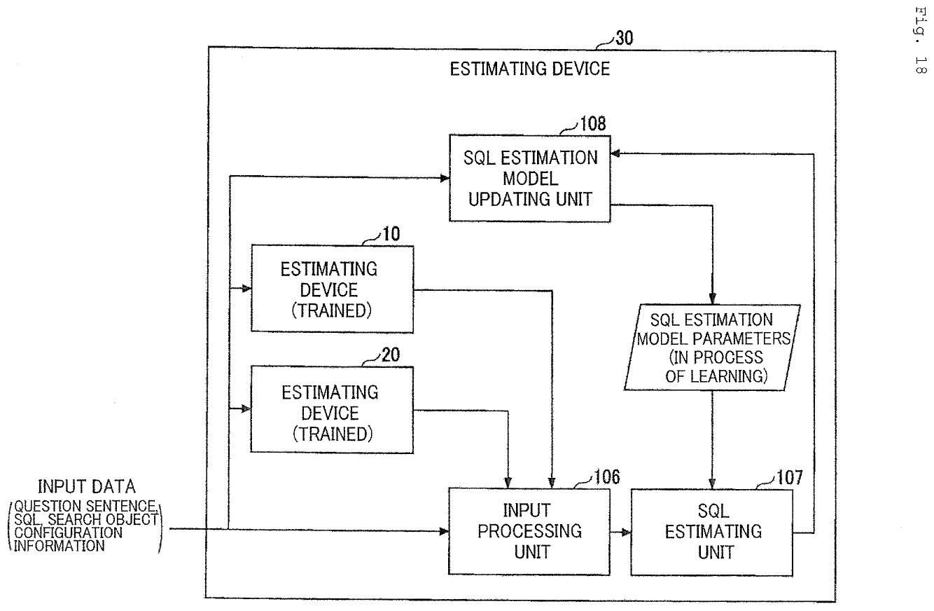

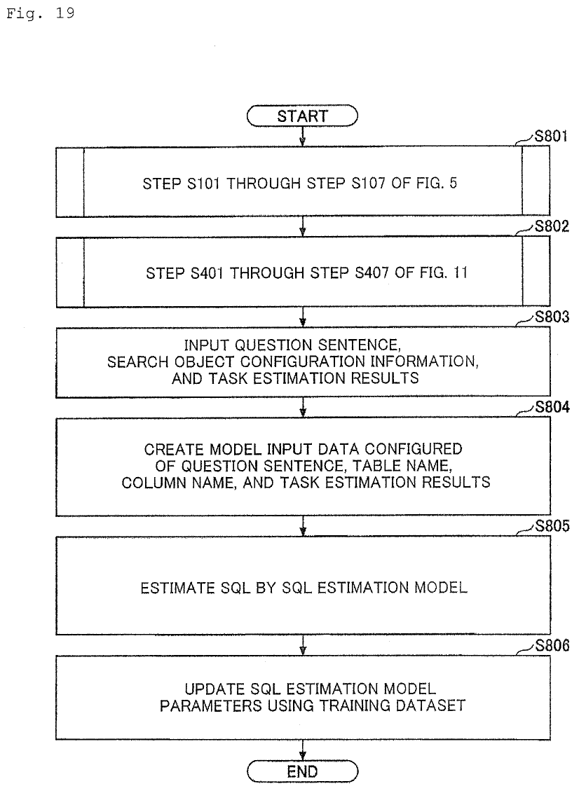

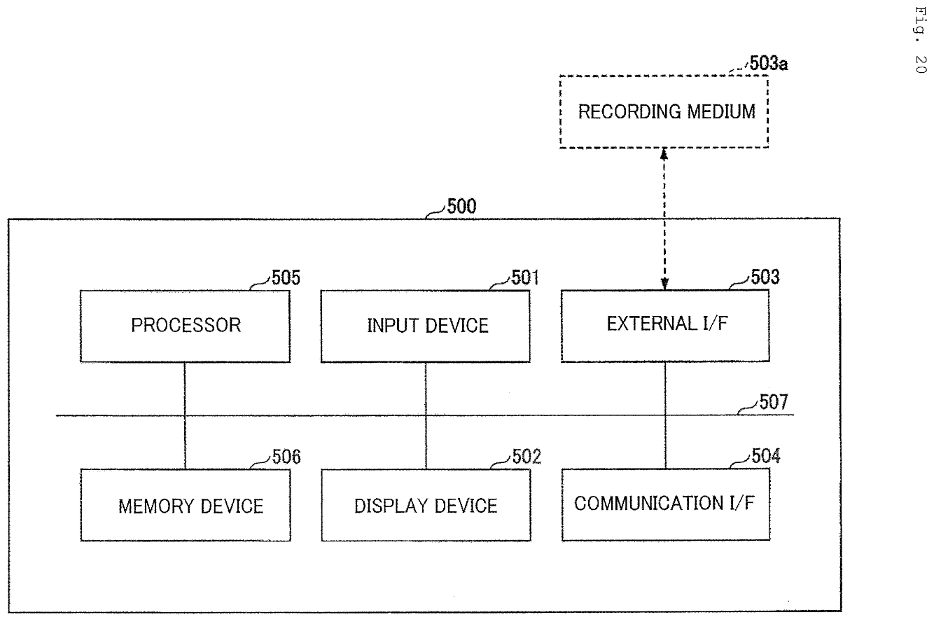

In concluding, the hardware configuration of the estimating device 10 according to Example 1, the estimating device 20 according to Example 2, and the estimating device 30 according to Example 3 will be described. The estimating device 10, estimating device 20, and estimating device 30 are realized by a hardware configuration of a general computer or computer system, and can be realized by a hardware configuration of a computer 500 illustrated in FIG. 20, for example. The computer 500 illustrated in FIG. 20 has, as hardware, an input device 501, a display device 502, an external I/F 503, a communication I/F 504, a processor 505, and a memory device 506. Each piece of this hardware is communicably connected with each other via a bus 507.

The input device 501 is, for example, a keyboard, a mouse, a touch panel, or the like. The display device 502 is, for example, a display or the like. Note that the computer 500 may be provided without at least one of the input device 501 and the display device 502.

The external I/F 503 is an interface for an external device such as a recording medium 503a or the like. Examples of the recording medium 503a include a CD (Compact Disc), a DVD (Digital Versatile Disk), an SD memory card (Secure Digital memory card), a USB (Universal Serial Bus) memory card, and so forth.

The communication I/F 504 is an interface for connecting the computer 500 to a communication network. The processor 505 is various types of computing devices such as, for example, a CPU, a GPU, and so forth. The memory device 506 is various types of storage devices such as, for example, an HDD, an SSD, RAM (Random Access Memory) , ROM (Read Only Memory) , flash memory, and so forth.

The above-described estimating device 10, the estimating device 20, and the estimating device 30 can realize the above-described estimating processing and learning processing by the hardware configuration of the computer 500 illustrated in FIG. 20, for example. Note that the hardware configuration of the computer 500 illustrated in FIG. 20 is only an example, and that the computer 500 may have other hardware configurations. For example, the computer 500 may have a plurality of processors 505, and may have a plurality of memory devices 506.

The present invention is not limited to the above embodiments disclosed in detail, and various types of modifications, alterations, combinations with known technology, and so forth, can be made without departing from the scope of the Claims.

### REFERENCE SIGNS LIST

10, 20, 30 Estimating device
101, 101A Input processing unit
102 Estimating unit
103 Comparison determining unit
104, 104A Learning data processing unit
105 Updating unit
106 Input processing unit
107 SQL estimating unit
108 SQL estimation model updating unit
111 Tokenizing unit
112 General-purpose language model unit
113 Converting unit

1. An estimating device, comprising:
a processor; and
a memory storing program instructions that cause the processor to:
take a question sentence relating to a database and configuration information representing a configuration of the database as input, and create first input data configured of the question sentence, a table name of a table stored in the database, a column name of a column included in the table of the table name, and a value of the column; and
estimate whether a column name included in the first input data is used in an SQL query for searching the database for an answer with regard to the question sentence, using a first parameter that is trained in advance.

2. The estimating device according to claim 1,
wherein the program instructions further cause the processor to take the question sentence, the configuration information, and estimation results of the estimating as input, and create second input data configured of the question sentence, a table name of each table stored in the database, a column name of each column included in the table of the table name, and the estimation results with regard to the column name, and
estimate the SQL query from the second input data, using a second parameter that is trained in advance.

3. A learning device, comprising:
a processor; and
a memory storing program instructions that cause the processor to:
take a question sentence relating to a database and configuration information representing a configuration of the database as input, and create input data configured of the question sentence, a table name of a table stored in the database, a column name of a column included in the table of the table name, and a value of the column;
take the question sentence, the configuration information, and an SQL query for searching the database for an answer with regard to the question sentence, as input, and creates label data configured of the question sentence, a table name of a table stored in the database, a column name of a column included in the table of the table name, and a label indicating whether or not the column name is used in the SQL query;
estimate whether or not a column name included in the input data is used in the SQL query, using a parameter that is an object of learning; and
learn the parameter, using error between estimating results of the estimating, and a label having label data including the same question sentence, table name, and column name as the input data used for the estimating.

4. An estimating method to be performed by a computer, comprising:
taking a question sentence relating to a database and configuration information representing a configuration of the database as input, and creating first input data configured of the question sentence, a table name of a table stored in the database, a column name of a column included in the table of the table name, and a value of the column; and
estimating whether or not a column name included in the first input data is used in an SQL query for searching the database for an answer with regard to the question sentence, using a first parameter that is trained in advance.

5. (canceled)

6. A non-transitory computer-readable recording medium having stored therein a program that causes the computer to perform the estimating method according to claim 4.
